(19) United States
(12) Patent Application Publication
(10) Pub. No.: US 2006/0227305 A1
(43) Pub. Date: Oct. 12, 2006

(54) Multi-functional product having a releasing mechanism to activate the opening of a cover relative to a main body

(75) Inventors: Jae-hui Pee, Suwon-si (KR); Ho-Ill Hyun, Suwon-si (KR); Jae-yoon One, Yongin-si (KR); Yoon-soo Chung, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/397,736

(22) Filed: Apr. 5, 2006

(30) Foreign Application Priority Data
Apr. 6, 2005 (KR) 2005-28515

(51) Int. Cl. G03B 27/00

(52) U.S. Cl. 355/18

(57) ABSTRACT

A multi-functional product is provided. Such a multi-functional product comprises a main body, a cover on which at least one hook is formed and to which an elastic force is applied in a direction to open the cover away from the main body, a locking lever that locks the cover in a closed position by connecting with the hook through an elastic force applied to the locking lever, and a releasing mechanism including one or more releasing devices that release the locking lever from the hook by rotating the locking lever.

### CROSS-REFERENCE TO RELATED APPLICATIONS

This application claims all benefits accruing under 35 U.S.C. §119 from Korean Patent Application No. 10-2005-0028515, filed on Apr. 6, 2005, in the Korean Intellectual Property Office, the disclosure of which is incorporated by reference herein.

### BACKGROUND OF THE INVENTION

1. Field of the Invention

The present invention relates to a multi-functional product, and more particularly, to a multi-functional product having a cover that can be easily opened through a simple operation without being manually lifted.

2. Related Art

Generally, a multi-functional product is an apparatus that performs multiple functions, such as printing, scanning, faxing and photocopying, and may include a scanning unit that inputs an image after scanning a manuscript, a printing unit that prints the image, and/or other units, such as a facsimile unit.

FIG. 1 is a perspective view of a typical multi-functional product. Referring to FIG. 1, the multi-functional product includes a main body 10 on which a printing unit (not shown) is mounted, a scanning unit 20 mounted on an upper part of the main body 10 to scan an image from a manuscript, and an operation panel 30 on which operation buttons for selecting a functional operation are formed.

The scanning unit 20 scans an image by radiating light onto a manuscript placed on a transparent glass plate 23 using an image sensor (not shown) moving back and forth under the transparent glass plate 23, which is mounted on an upper part of the main body 10. The scanning unit 20 includes a cover 21 that blocks light radiated from the image sensor (not shown) from traveling outside the scanning unit 20. The cover 21 is designed to be opened and closed by a plurality of coupling units 22 connected to the main body 10.

To scan a manuscript, each sheet of the manuscript is placed on the transparent glass plate 23 and the cover 21 is in a closed position. Then, an image on each sheet of the manuscript is scanned by radiating light onto the manuscript while the image sensor (not show) is moving back and forth under the transparent glass 23.

To scan a second manuscript after scanning a first manuscript, the first manuscript is removed from the transparent glass plate 23 by manually opening the cover 21 and the second manuscript is placed on the transparent glass plate 23. After closing the cover 21, an image of the second manuscript is scanned by reusing the image sensor (not shown).

When multiple manuscripts are to be scanned, the above operation for scanning each manuscript must be repeated until all manuscripts are completed.

When an automatic manuscript supplying device is included in the multi-functional product, the above operations are unnecessary. However, when there is no automatic manuscript supplying device, the above operation for scanning one manuscript must be repeated to scan a plurality of manuscripts.

### SUMMARY OF THE INVENTION

Various aspects and example embodiments of the present invention provide a multi-functional product having a cover that can improve work efficiency by reducing unnecessary operations for scanning manuscripts.

Additional aspects and/or advantages of the invention will be set forth in part in the description which follows and, in part, will be obvious from the description, or may be learned by practice of the invention.

In accordance with an aspect of the present invention, a multi-functional product comprises: a main body; a cover on which at least one hook is formed and to which an elastic force is applied in a direction to open the cover away from the main body, a locking lever arranged to lock the cover in a closed position by connecting with the hook on the cover through an elastic force applied to the locking lever, and a releasing mechanism including one or more releasing devices that release the locking lever from the hook by rotating the locking lever.

According to an aspect of the present invention, an image sensor is further provided to perform a scanning operation, and the releasing mechanism comprises a manual releasing device arranged to enable a user to manually release the locking lever from the hook on the cover, thereby opening the cover relative to the main body; and an automatic releasing device arranged to automatically release the locking lever from the hook on the cover, when a scanning operation of the image sensor is completed.

The manual releasing device comprises a releasing lever protruding outward from the main body such that a force applied to the releasing lever causes the locking lever to rotate, and rotates the locking lever in a releasing direction away from the hook on the cover by contacting the locking lever; and an elastic member arranged to apply an elastic force to the releasing lever causing the releasing lever to separate in a direction from the locking lever.

The automatic releasing device comprises an automatic releasing unit including an electromagnet, arranged to release the locking lever from the hook on the cover by rotating the locking lever through an electromagnetic force generated by the electromagnet; a sensing unit arranged to detect a scanning operation performed by the image sensor; and a control unit arranged to control the release of the hook on the cover from the locking lever by operating the automatic releasing unit to rotate the locking lever toward the automatic releasing unit when the sensing unit detects the completion of the scanning operation of the image sensor.

The electromagnet generates an electromagnetic force when power is applied, and the releasing lever is formed of a metal that responds to the electromagnetic force, and when power is supplied to the electromagnet, the releasing lever is separated from the hook on the cover and contacts the electromagnet and, when power is not supplied, the releasing lever is returned to its original position through an elastic force applied by a spring.

In accordance with another aspect of the present invention, an image forming apparatus comprises a main body having a glass plate providing a scanning surface and an image sensor arranged under the glass plate to scan a document placed on the scanning surface; a cover arranged to rotate between an open position to open the scanning surface and a close position to close the scanning surface; a locking lever arranged inside the main body to lock the cover when the cover is in the close position; and a releasing mechanism arranged to release the locking lever, via one of a user's action and a predetermined condition based on the image sensor.

According to an aspect of the present invention, the releasing mechanism comprises a manual releasing device arranged to enable a user to manually release the locking lever from a hook on the cover, thereby enabling the cover to open relative to the main body; and an automatic releasing device arranged to automatically release the locking lever from the hook on the cover, when a scanning operation of the image sensor is completed.

The manual releasing device comprises a releasing lever protruding outward from the main body and having a release button at a distal end such that a force applied to the release button causes the locking lever to rotate, and rotates the locking lever in a releasing direction away from the hook on the cover; and an elastic member arranged to apply an elastic force to the releasing lever causing the releasing lever to separate in a direction from the locking lever.

The automatic releasing device comprises an automatic releasing unit including an electromagnet, arranged to release the locking lever from the hook on the cover by rotating the locking lever through an electromagnetic force generated by the electromagnet; a sensing unit arranged to detect a scanning operation performed by the image sensor; and a control unit arranged to control the release of the hook on the cover from the locking lever by operating the automatic releasing unit to rotate the locking lever toward the automatic releasing unit when the sensing unit detects the completion of the scanning operation of the image sensor.

According to an aspect of the present invention, the releasing mechanism can alternatively be arranged to enable a user to manually release the locking lever from a hook on the cover, thereby enabling the cover to open relative to the main body. Such a releasing mechanism may comprise a releasing lever protruding outward from the main body and having a release button at a distal end such that a force applied to the release button causes the locking lever to rotate, and rotates the locking lever in a releasing direction away from the hook on the cover; and an elastic member arranged to apply an elastic force to the releasing lever causing the releasing lever to separate in a direction from the locking lever.

According to another aspect of the present invention, the releasing mechanism can further be arranged to automatically release the locking lever from the hook on the cover, when a scanning operation of the image sensor is completed. Such a releasing mechanism may comprise an automatic releasing unit including an electromagnet, arranged to release the locking lever from the hook on the cover by rotating the locking lever through an electromagnetic force generated by the electromagnet; a sensing unit arranged to detect a scanning operation performed by the image sensor; and a control unit arranged to control the release of the hook on the cover from the locking lever by operating the automatic releasing unit to rotate the locking lever toward the automatic releasing unit when the sensing unit detects the completion of the scanning operation of the image sensor.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a perspective view of an example mult-functional product;

FIG. 2 is a perspective view of a multi-functional product having a releasing mechanism according to an embodiment of the present invention;

FIG. 3 is a partial perspective view of an example hinge connection between a cover relative to a main body of a multi-functional product shown in FIG. 2;

FIG. 4 is a lateral cross-sectional view of an example releasing mechanism usable in a multi-functional product shown in FIG. 2;

FIG. 5 is a lateral cross-sectional view of an example releasing mechanism when a manual releasing device is used to release a locking lever for opening a cover relative to a main body of a multi-functional product shown in FIG. 2;

FIG. 6 is a lateral cross-sectional view of an example releasing mechanism when an automatic releasing device is used to release a locking lever for opening a cover relative to a main body of a multi-functional product shown in FIG. 2; and

FIG. 7 is a block diagram of an automatic releasing device shown in FIG. 6.

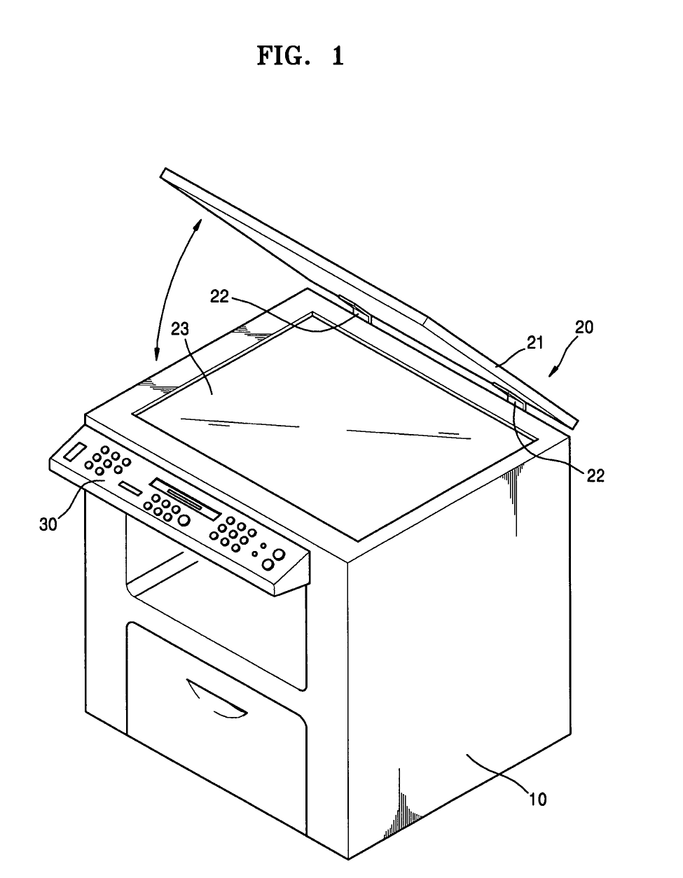

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

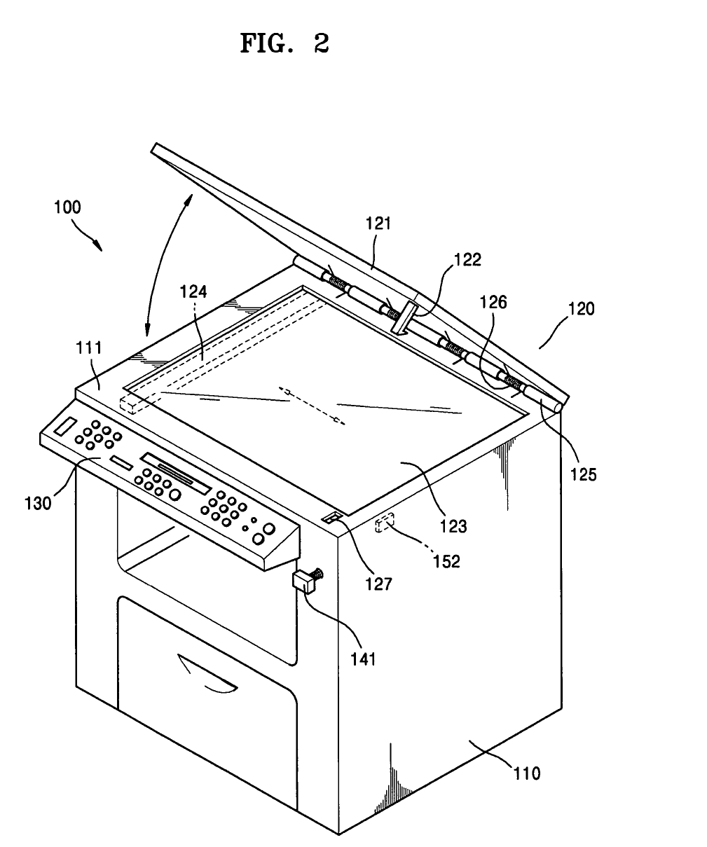

FIG. 2 illustrates an example multi-functional product including a releasing mechanism according to an embodiment of the present invention. While such a multi-functional product is shown in FIG. 2, a releasing mechanism according to example embodiments of the present invention can also be incorporated into an image forming apparatus, such as a photocopier, that utilizes a cover to open and close an image scanning section relative to a main body.

Referring to FIG. 2, a multi-functional product 100 includes a main body 110 in which a printing unit (not shown) is mounted, a scanning unit 120 mounted on an upper part 111 of the main body 110 to scan an image of a manuscript (not shown), and an operation panel 130 on which a plurality of operation buttons are disposed.

The scanning unit 120 includes an image sensor 124 that scans an image by irradiating light onto a manuscript placed on an upper part of a transparent glass plate 123 by moving back and forth as indicated by an arrow under the transparent glass plate 123, which is mounted on an upper part 111 of the main body 110, and a cover 121 that covers the transparent glass plate 123 to shield light radiated from the image sensor 124 from traveling outside the scanning unit 120.

The cover 121 closes and opens the scanning unit 120 by rotating about a rotation axis of a hinge 125 arranged at one end of the main body 110.

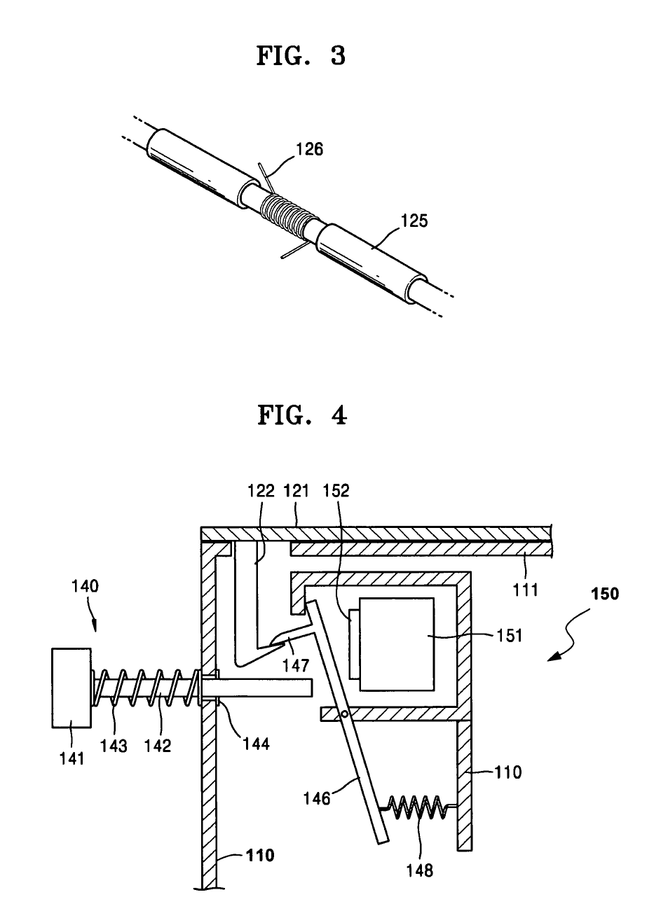

Referring to FIG. 3, the cover 121 is always maintained in an opened state by an elastic force applied to the cover 121 in an upward direction by a plurality of elastic members 126 as long as an external force in a downward direction is not applied to the cover 121.

The cover 121 includes a hook 122 connected to a side of the main body 110, and the hook 122 can be connected to a latch or an inserting groove, which will be described later. An inserting groove 127 into which the hook 122 can be inserted therein is formed in the upper part 111 of the main body 110. Although not shown in FIG. 2, one or more hooks 122 can be formed on the cover 121 and one or more inserting grooves 127 can be formed in the upper part 111 to correspond to the hooks 122 so as to close the cover 121 relative to the main body 110.

A release mechanism, which can be manual and/or automatic, can be incorporated into one side (i.e., a front side) of the main body 110 to enable a cover 121 to open relative to the main body 110, via a simple manual action or an automatic action based on certain conditions, such as, for example, upon completion of an image scanning operation.

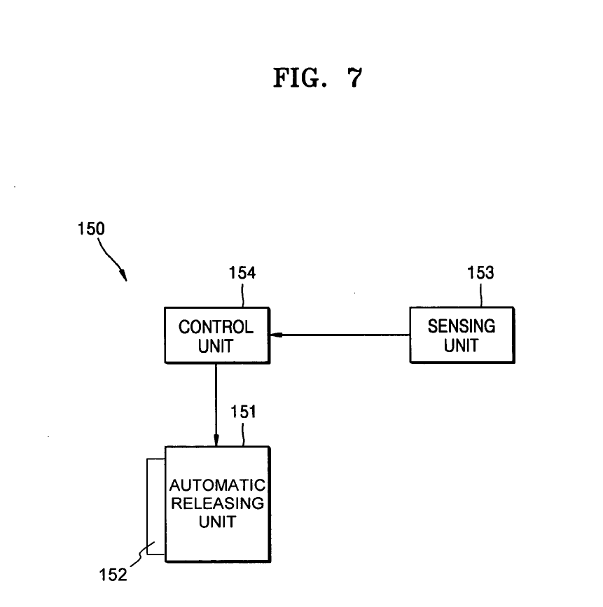

For example, FIG. 4 illustrates a lateral cross-sectional view of an example releasing mechanism according to an embodiment of the present invention. Referring to FIG. 4, the releasing mechanism includes a locking lever 146 arranged to lock the cover 121 on the upper part 111 of the main body 110, by rotating about an axis to latch on the hook 122 of the cover 121, when the cover 121 is in a closed position relative to the main body 110; a manual releasing device 140 arranged to enable a user to manually release the locking lever 146 from the hook 122, via a simple button 141; and an automatic releasing device 150 (see FIG. 7) arranged to automatically release the locking lever 146 from the hook 122, via an electromagnetic force, based on certain conditions, thereby opening the cover 121 relative to the main body 110.

The locking lever 146 is rotatably mounted to the main body 110, and includes a locking unit 147 disposed on one side to connect to the hook 122 and an elastic member 148 that applies an elastic force to the locking lever 146 and forces the locking unit 147 to lock the hook 122 on the cover 121 in place in its natural position. Accordingly, the locking lever 146 is rotated by the elastic member 148 in a direction to connect to the hook 122 on the cover 121. Moreover, the hook 122 on the cover 121 is designed such that, when the cover 121 is closed, gravity will push the hook 122 downward to latch onto the locking unit 147 of the locking lever 146.

The manual releasing device 140 can be arranged to separate the locking unit 147 of the locking lever 146 from the hook 122 on the cover 121 to open the cover 121 relative to the main body 110 by applying a force to the locking lever 146 greater than the elastic force using a hand or a tool to rotate the locking lever 146. The manual releasing device 140 includes a button 141, a releasing lever 142, a spring 143 and a stopper 144.

The releasing lever 142 is mounted in the main body 110 can slide to contact or separate from the locking lever 146. The releasing lever 142 includes a button 141 protruded outward from the main body 110 for the user to apply a force thereto, and a stopper 144 that confines a sliding distance to prevent the releasing lever 142 from separating from the main body 110.

The spring 143 applies an elastic force in a direction to separate the releasing lever 142 from the locking lever 146.

The automatic releasing device 150 can be arranged, optionally, at the back end of the locking lever 146, and includes an automatic releasing unit 151 which utilizes an electromagnetic force, via an electromagnet 152, or a solenoid force, to release the locking lever 146 from the hook 122 on the cover 121 in accordance with certain conditions, such as, upon completion of an image scanning operation of the image sensor 124.

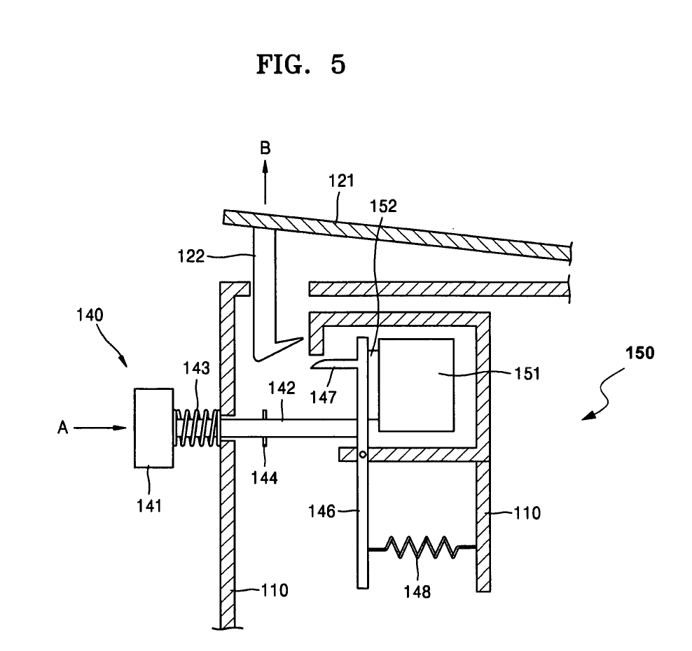

FIG. 5 is a lateral cross-sectional view of an example releasing mechanism when a manual releasing device is used to release a locking lever for opening a cover relative to a main body of a multi-functional product shown in FIG. 2. Referring to FIG. 5, when the user presses the button 141 using a force greater than the elastic force of the spring 143, the releasing lever 142 is slid in a direction indicated by the arrow A and pushes the locking lever 146 to rotate in a clockwise direction.

The locking unit 147 at the distal end of the locking lever 146 releases the hook 122 on the cover 121 due to the rotation of the locking lever 146 in a clockwise direction. Then, the cover 121 is opened in a direction indicated by the arrow B by the elastic members 126 (see FIGS. 2 and 3).

When the force applied to the button 141 is released, the releasing lever 142 is returned to the original position, as depicted in FIG. 4, by the elastic force of the spring 143.

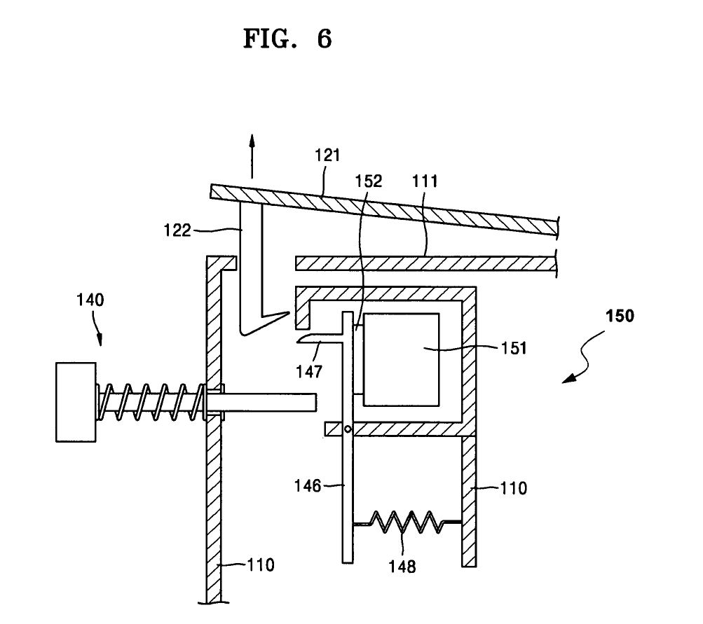

FIG. 6 is a lateral cross-sectional view of an example releasing mechanism when an automatic releasing device is used to release a locking lever for opening a cover relative to a main body of a multi-functional product shown in FIG. 2. FIG. 7 is a block diagram of an automatic releasing device shown in FIG. 6. Referring to FIGS. 4 through 7, the automatic releasing device 150 includes an automatic releasing unit 151, a sensing unit 153, and a control unit 154.

The automatic releasing unit 151 releases the connection between the locking lever 146 and the hook 122 through the rotation of the locking lever 146 by causing the locking lever 146 to contact or separate from the automatic releasing unit 151, and includes an electromagnet 152 that generates a magnetic force when power is supplied thereto. The locking lever 146 may be formed of a metal that can be attracted to the electromagnet 152. The automatic releasing unit 151 does not necessarily use an electromagnetic force, and various elements that can rotate the locking lever 146 by applying a force greater than the elastic force applied to the locking lever 146 can be used, such as a solenoid.

The sensing unit 153, as shown in FIG. 7, detects the operation of the image sensor 124. The sensing unit 153 detects the completion of the operation of the image sensor 124 when scanning an image of a manuscript.

When the sensing unit 153 detects the completion of the image scanning operation of the image sensor 124, as shown in FIG. 6, the control unit 154, as shown in FIG. 7, releases the locking unit 147 from the hook 122 on the cover 121 by controlling the automatic releasing unit 151 to rotate the locking lever 146 to contact the electromagnet 152. Then, the cover 121 is opened by the elastic force of the elastic member 125.

When the control unit 154 disconnects power supply to the automatic releasing unit 151, the locking unit 147 is separated from the electromagnet 152 and returns to the original position due to the elastic force of the spring 148.

Accordingly, when an image of a manuscript is scanned after placing the manuscript on the transparent glass plate 123 and closing the cover 121, the control unit 154 releases the locking lever 146 from the hook 122 by operating the automatic releasing unit 151 in response to a signal indicating the completion of the image scanning operation of the image sensor 124 detected by the sensing unit 153.

Then, the cover 121 is opened. To scan another manuscript, the manuscript of which an image has already been scanned is removed from the transparent glass plate 123 and the other manuscript is placed on the transparent glass plate 123. After closing the cover 121, an image of the other manuscript is scanned.

The use of the automatic releasing device 150 can be selected by configuring a selection mode for operating manually or automatically.

The present invention can be applied to not only multi-functional products or peripherals but also other various products with covers that must be closed/opened to perform a scanning function.

As described above, the multi function peripheral according to the present invention has the following advantages. First, the cover can be opened through a simple operation, thereby removing the inconveniences for users. Second, the scanning time can be reduced since the manuscript can be replaced, while the image sensor returns to the original position since the cover is automatically opened after completion of scanning by the image sensor. Third, the retrieval of the last manuscript that has been scanned can not be missed because the last manuscript is seen when the scanning is completed since the cover is automatically opened.

While the present invention has been particularly shown and described with reference to exemplary embodiments thereof, it will be understood by those of ordinary skill in the art that various changes in form and details may be made therein without departing from the spirit and scope of the present invention

For example, components of the releasing mechanism including one or more releasing devices can be arranged differently and at different locations on the main body of a multi-functional product. The push button for a manual release operation and the automatic releasing unit for an automatic release operation can be arranged anywhere on the main body of a multi-functional product. In addition, the control unit and the sensing unit, as shown in FIG. 7, can be incorporated into a main controller to control all operations of the multi-functional product, including one or more driving motors and the laser scanning unit to reduce cost. Accordingly, it is intended, therefore, that the present invention not be limited to the various example embodiments disclosed, but that the present invention includes all embodiments falling within the scope of the appended claims.

What is claimed is:

1. A multi-functional product comprising:
a main body;
a cover on which at least one hook is formed and to which an elastic force is applied in a direction to open the cover from the main body;
a locking lever arranged to lock the cover in a closed position by connecting with the hook through an elastic force applied to the locking lever; and
one or more releasing devices arranged to release the locking lever from the hook by rotating the locking lever.

2. The multi-functional product as claimed in claim 1, further comprising an image sensor for performing a scanning operation, and wherein the one or more releasing devices comprise:
a manual releasing device arranged to enable a user to manually release the locking lever from the hook on the cover, thereby opening the cover relative to the main body; and
an automatic releasing device arranged to automatically release the locking lever from the hook on the cover, when a scanning operation of the image sensor is completed.

3. The multi-functional product as claimed in claim 2, wherein the manual releasing device comprises:
a releasing lever protruding outward from the main body such that a force applied to the releasing lever causes the locking lever to rotate, and rotates the locking lever in a releasing direction away from the hook on the cover by contacting the locking lever; and
an elastic member arranged to apply an elastic force to the releasing lever causing the releasing lever to separate in a direction from the locking lever.

4. The multi-functional product as claimed in claim 2, wherein the automatic releasing device comprises:
an automatic releasing unit including an electromagnet, arranged to release the locking lever from the hook on the cover by rotating the locking lever through an electromagnetic force generated by the electromagnet;
a sensing unit arranged to detect a scanning operation performed by the image sensor; and
a control unit arranged to control the release of the hook on the cover from the locking lever by operating the automatic releasing unit to rotate the locking lever toward the automatic releasing unit when the sensing unit detects the completion of the scanning operation of the image sensor.

5. The multi-functional product as claimed in claim 4, wherein, the electromagnet generates an electromagnetic force when power is applied, and the releasing lever is formed of a metal that responds to the electromagnetic force, and when power is supplied to the electromagnet, the releasing lever is separated from the hook on the cover and contacts the electromagnet and, when power is not supplied, the releasing lever is returned to its original position through an elastic force applied by a spring.

6. An apparatus comprising:
a main body having a glass plate providing a scanning surface and an image sensor arranged under the glass plate to scan a document placed on the scanning surface;
a cover arranged to rotate between an open position to open the scanning surface and a close position to close the scanning surface;
a locking lever arranged inside the main body to lock the cover when the cover is in the close position; and
a releasing mechanism arranged to release the locking lever, via one of a user's action and a predetermined condition based on the image sensor.

7. The apparatus as claimed in claim 6, wherein the releasing mechanism comprises:
a manual releasing device arranged to enable a user to manually release the locking lever from a hook on the cover, thereby enabling the cover to open relative to the main body; and
an automatic releasing device arranged to automatically release the locking lever from the hook on the cover, when a scanning operation of the image sensor is completed.

8. The apparatus as claimed in claim 7, wherein the manual releasing device comprises:
a releasing lever protruding outward from the main body and having a release button at a distal end such that a force applied to the release button causes the locking lever to rotate, and rotates the locking lever in a releasing direction away from the hook on the cover; and
an elastic member arranged to apply an elastic force to the releasing lever causing the releasing lever to separate in a direction from the locking lever.

9. The apparatus as claimed in claim 7, wherein the automatic releasing device comprises:
an automatic releasing unit including an electromagnet, arranged to release the locking lever from the hook on the cover by rotating the locking lever through an electromagnetic force generated by the electromagnet;
a sensing unit arranged to detect a scanning operation performed by the image sensor; and
a control unit arranged to control the release of the hook on the cover from the locking lever by operating the automatic releasing unit to rotate the locking lever toward the automatic releasing unit when the sensing unit detects the completion of the scanning operation of the image sensor.

10. The apparatus as claimed in claim 9, wherein, the electromagnet generates an electromagnetic force when power is applied, and the releasing lever is formed of a metal that responds to the electromagnetic force, and when power is supplied to the electromagnet, the releasing lever is separated from the hook on the cover and contacts the electromagnet and, when power is not supplied, the releasing lever is returned to its original position through an elastic force applied by a spring.

11. The apparatus as claimed in claim 6, wherein the releasing mechanism is arranged to enable a user to manually release the locking lever from a hook on the cover, thereby enabling the cover to open relative to the main body.

12. The apparatus as claimed in claim 11, wherein the releasing mechanism comprises:
a releasing lever protruding outward from the main body and having a release button at a distal end such that a force applied to the release button causes the locking lever to rotate, and rotates the locking lever in a releasing direction away from the hook on the cover; and
an elastic member arranged to apply an elastic force to the releasing lever causing the releasing lever to separate in a direction from the locking lever.

13. The apparatus as claimed in claim 7, wherein the releasing mechanism is arranged to automatically release the locking lever from the hook on the cover, when a scanning operation of the image sensor is completed.

14. The apparatus as claimed in claim 13, wherein the releasing mechanism comprises:
an automatic releasing unit including an electromagnet, arranged to release the locking lever from the hook on the cover by rotating the locking lever through an electromagnetic force generated by the electromagnet;
a sensing unit arranged to detect a scanning operation performed by the image sensor; and
a control unit arranged to control the release of the hook on the cover from the locking lever by operating the automatic releasing unit to rotate the locking lever toward the automatic releasing unit when the sensing unit detects the completion of the scanning operation of the image sensor.

15. The apparatus as claimed in claim 14, wherein, the electromagnet generates an electromagnetic force when power is applied, and the releasing lever is formed of a metal that responds to the electromagnetic force, and when power is supplied to the electromagnet, the releasing lever is separated from the hook on the cover and contacts the electromagnet and, when power is not supplied, the releasing lever is returned to its original position through an elastic force applied by a spring.
